(19) United States
(12) Patent Application Publication
(10) Pub. No.: US 2026/0277497 A1
(43) Pub. Date: Sep. 17, 2026

(54) CLOUD PRINT SERVER SYSTEM, INFORMATION PROCESSING SYSTEM, CONTROL METHOD FOR CLOUD PRINT SERVER SYSTEM, AND STORAGE MEDIUM

(71) Applicant: CANON KABUSHIKI KAISHA, Tokyo (JP)

(72) Inventor: Arata Myoga, Kanagawa (JP)

(21) Appl. No.: 19/554,873

(22) Filed: Mar. 3, 2026

(30) Foreign Application Priority Data
Mar. 11, 2025 (JP) 2025-038548

(51) Int. Cl. G06F 3/12

(52) U.S. Cl. CPC G06F 3/1205; G06F 3/1274; G06F 3/1287

(57) ABSTRACT

A cloud print server system which is connected to a first cloud print server system and provides a cloud print service, the cloud print server system acquires a first print job including first print setting information supported by a standard print function of an operating system; and converts the first print setting information included in the first print job that is acquired into second print setting information defined by a predetermined protocol for using the cloud print service, wherein the cloud print server converts third print setting information into fourth print setting information defined by the predetermined protocol in a case where the first print job further includes the third print setting information that extends the standard print function.

### BACKGROUND

### Field of the Technology

The present disclosure relates to a cloud print server system, an information processing system, a control method for a cloud print server system, and a storage medium

### Description of the Related Art

An operating system (OS) of recent years is equipped with a print function as standard (hereinafter, also called a standard print function). In order to provide a user with print settings that are not supported by the standard print function, a vendor of a printing apparatus provides a print support application (PSA) that can be installed in the OS. The standard print function uses a standard protocol such as Internet Printing Protocol (IPP) to communicate with a printing apparatus and a print server. In IPP, the vendor of the printing apparatus can independently define a vendor-specific extended attribute. Japanese Patent Laid-Open No. 2024-140680 proposes a technique for executing printing for a print job in which print settings supported by the standard print function and print settings not supported by the standard print function coexist.

There is a cloud print service in which a print job is submitted to a print server via a cloud and the job is transmitted from this print server to a printing apparatus. In the cloud print service, a print job created with a print setting supported by the standard print function is converted into a print protocol for the cloud print service. In such a case, it is conceivable that a print setting not supported by the standard print function is not converted into the print protocol for the cloud print service, and a printed matter not reflecting this print setting is output.

### SUMMARY

The present disclosure enables realization of a technique for reflecting, in printing using a cloud print service, print setting information not supported by a standard print function of an OS in a case where a print job is submitted via a cloud.

One aspect of the present disclosure provides a cloud print server system which is connected to a first cloud print server system and provides a cloud print service, the cloud print server system comprising: one or more memory devices that store a set of instructions; and one or more processors that execute the set of instructions to: acquire a first print job including first print setting information supported by a standard print function of an operating system; and convert the first print setting information included in the first print job that is acquired into second print setting information defined by a predetermined protocol for using the cloud print service, wherein the one or more processors further execute instructions in the one or more memory devices to: convert third print setting information into fourth print setting information defined by the predetermined protocol in a case where the first print job further includes the third print setting information that extends the standard print function.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an information processing system according to one embodiment.

FIG. 2 is a hardware configuration diagram of a computer according to one embodiment.

FIG. 3 is a hardware configuration diagram of a printing apparatus according to one embodiment.

FIG. 4 is a hardware configuration diagram of an information processing apparatus according to one embodiment.

FIG. 5 is a functional block diagram of a printing apparatus according to one embodiment.

FIG. 6 is a functional block diagram of a first print server according to one embodiment.

FIG. 7 is a functional block diagram of a second print server according to one embodiment.

FIG. 8 is a flowchart of processing according to one embodiment.

FIG. 9 is a flowchart of processing according to one embodiment.

FIG. 10 is a flowchart of processing according to one embodiment.

FIG. 11 is a flowchart of processing according to one embodiment.

FIG. 12 is a flowchart of processing according to one embodiment.

FIG. 13 is a flowchart of processing according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration Example

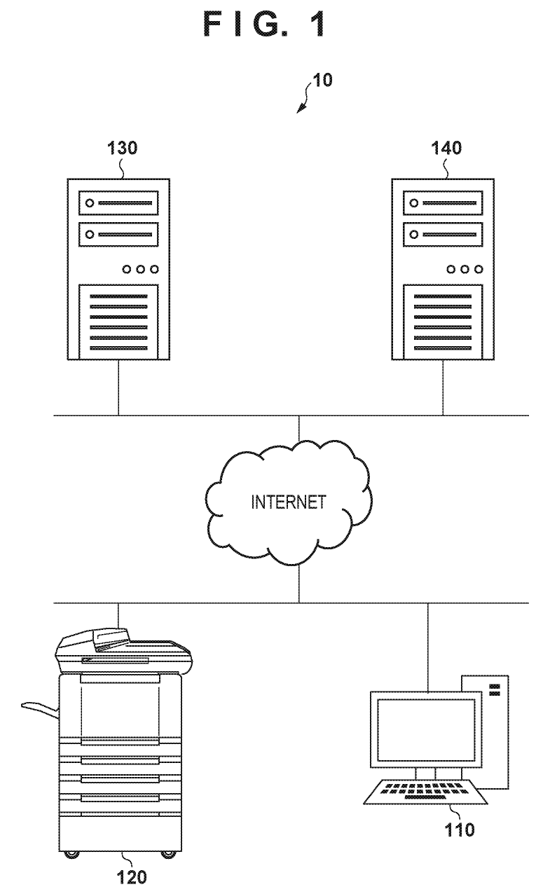

An outline of an information processing system according to a first embodiment will be described with reference to FIG. 1. An information processing system 10 is configured to include an information processing apparatus 110, a printing apparatus 120, a first print server 130 (an example of "another cloud print server system"), and a second print server 140 (an example of a "cloud print server system"). The information processing apparatus 110, the printing apparatus 120, the first print server 130, and the second print server 140 are mutually connected via the Internet. The information processing apparatus 110 and the printing apparatus 120 may be directly connected by a local area network. The Internet may be a wide area network, a cellular network, a local area network, another network, or any combination of these networks.

The information processing apparatus 110 provides a print function to a user of the information processing apparatus 110. The information processing apparatus 110 may be, for example, a personal computer (PC), a smartphone, or another device. The information processing apparatus 110 may designate, as an output destination of the printed matter, a physical printer (e.g., the printing apparatus 120) connected to the same local area network. Note that printing performed by directly (i.e., in the LAN) submitting a print job to a physical printer is also called local print or local printing in the following description. The information processing apparatus 110 may designate, as an output destination of the printed matter, a logical printer provided by the first print server 130. In a case where a logical printer is designated as an output destination, a physical printer (e.g., the printing apparatus 120) associated with the logical printer performs printing.

The information processing apparatus 110 using a cloud print service is also called a client or a client terminal. Printing performed by submitting a print job to a logical printer is also called cloud print, remote print, or remote printing. Printing performed by submitting a print job to the logical printer may be executed by the printing apparatus 120 connected to the same local area network as that of the information processing apparatus 110, or may be executed by a printing apparatus not connected to the local area network. In the example of FIG. 1, the information processing apparatus 110 can execute both local print and remote print. Alternatively, the information processing apparatus 110 may be able to execute only one of local print and remote print.

The information processing apparatus 110 may have a print function included in the operating system (OS) as standard. Such a print function is called a standard print function. The standard print function is also called an OS standard print function or a native print function. The information processing apparatus 110 having a standard print function does not require separate software (e.g., the driver) to use a printing apparatus supporting the standard print function. Examples of the standard print function include Airprint (registered trademark) included as standard in iOS (registered trademark), MacOS (registered trademark), or the like. Examples of the standard print function include Mopria (registered trademark) included as standard in Windows (registered trademark), Android (registered trademark), or the like.

The printing apparatus 120 has a print function that performs printing in accordance with a print job. The printing apparatus 120 may include at least one of a scanner function and a fax function in addition to the print function. The printing apparatus having such a plurality of functions is also called a multifunction peripheral (MFP). Alternatively, the printing apparatus 120 may be a single function peripheral (SFP) having only a print function. The printing may be printing on a sheet-like recording medium such as paper, or may be molding of a three-dimensional object (what is called three-dimensional printing). The printing method of the printing apparatus 120 may be an inkjet method that performs recording using ink, or a toner method that uses a recording material such as toner.

The first print server 130 and the second print server 140 provide a cloud print service in accordance with the print job generated by the information processing apparatus 110. That is, the first print server 130 and the second print server 140 transmit the print job to any (e.g., the printing apparatus 120) of one or more printing apparatuses in a state of being registered in the first print server 130 and the second print server 140. For example, the first print server 130 and the second print server 140 provide a logical printer to the information processing apparatus 110, and accept a print job for the logical printer. The logical printer is a virtual printing apparatus (e.g., a printer object) provided by the first print server 130 and the second print server 140. The logical printer is also called a cloud printer.

Note that the information processing apparatus 110 can generate a print queue for the logical printer. In contrast to the logical printer, a physical printing apparatus such as the printing apparatus 120 is also called a physical printer. In the following description, the logical printer and the physical printer are collectively represented simply as a printer. The physical printer can also be called a local printer in a case of being connected to the same LAN as that of the information processing apparatus that submits the print job.

The first print server 130 and the second print server 140 may be servers in an on-premises environment connected to the Internet or servers in a cloud computing environment (hereinafter, simply represented as a cloud). The first print server 130 and the second print server 140 may be connected to, for example, another server system (an example of a "first cloud print server system") that is provided on a cloud and provides UNIVERSALPRINT (registered trademark). Then, the first print server 130 and the second print server 140 may provide a cloud print service in cooperation with the other server system.

Examples of the cloud print service include UNIVERSALPRINT (registered trademark) provided by Microsoft Corporation.

The information processing apparatus 110, the first print server 130, and the second print server 140 communicate using a first communication protocol, and the second print server 140 and the printing apparatus 120 communicate using a second communication protocol. IPP and the like are exemplified as the first communication protocol, and Common Peripheral Controlling Architecture (CPCA) and the like are exemplified as the second communication protocol. CPCA is a vendor-specific protocol of the printing apparatus 120. The first communication protocol and the second communication protocol may be the same communication protocol. Note that CPCA is an example of a "predetermined protocol".

### Hardware Configuration of Computer

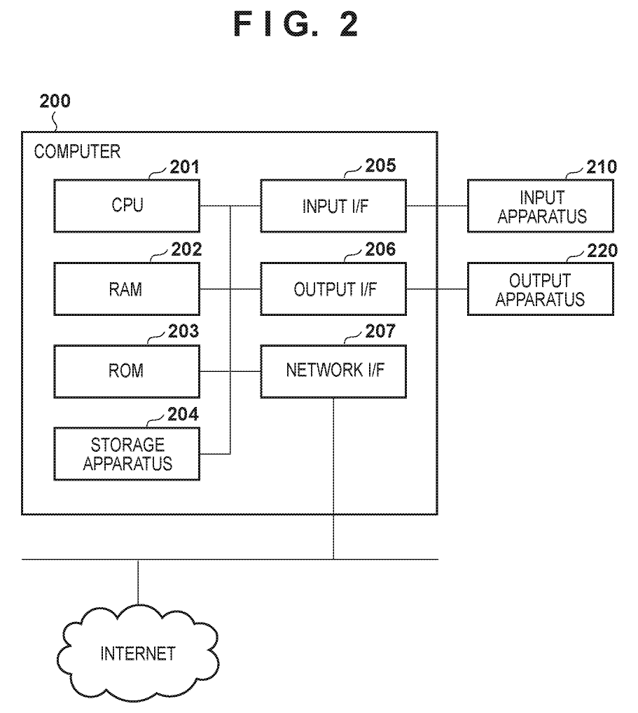

A hardware configuration of a computer 200 will be described with reference to FIG. 2. The computer 200 may be used as the information processing apparatus 110, or may be used as the first print server 130 and the second print server 140.

The computer 200 is configured to include a central processing unit (CPU) 201, a random access memory (RAM) 202, a read-only memory (ROM) 203, and a storage apparatus 204. The computer 200 is configured to include an input interface (I/F) 205, an output I/F 206, and a network I/F 207.

The CPU 201 is a general-purpose processing circuit that controls the overall operation of the computer 200. The RAM 202 is a volatile memory circuit and is used as a temporary storage area such as a work area for processing by the CPU 201. The ROM 203 is a nonvolatile memory circuit, and stores programs and data to be used in the processing of the CPU 201. The storage apparatus 204 is a nonvolatile storage apparatus, and stores programs and data to be used in the processing of the CPU 201. The storage apparatus 204 may be, for example, a hard disk drive (HDD) or a solid state drive (SSD). The storage apparatus 204 is also called a secondary storage apparatus. The operation by the computer 200 may be implemented by the CPU 201 executing a program read from the storage apparatus 204 into the RAM 202.

The input I/F 205 is an I/F for exchanging signals with an input apparatus 210. The input apparatus 210 is an apparatus that acquires an input from a user of the computer 200. The input apparatus 210 may be, for example, a keyboard, a touch panel, a microphone, a mouse, or any combination thereof. The output I/F 206 is an I/F for exchanging signals with an output apparatus 220. The output apparatus 220 is an apparatus that provides the user of the computer 200 with information. The output apparatus 220 may be, for example, a display, a speaker, or any combination thereof. Note that the input apparatus 210 or the output apparatus 220 may be configured integrally with the computer 200. The network I/F 207 is an I/F for communicating with an apparatus external to the computer 200, and is configured to include a communication module.

### Hardware Configuration of Printing Apparatus

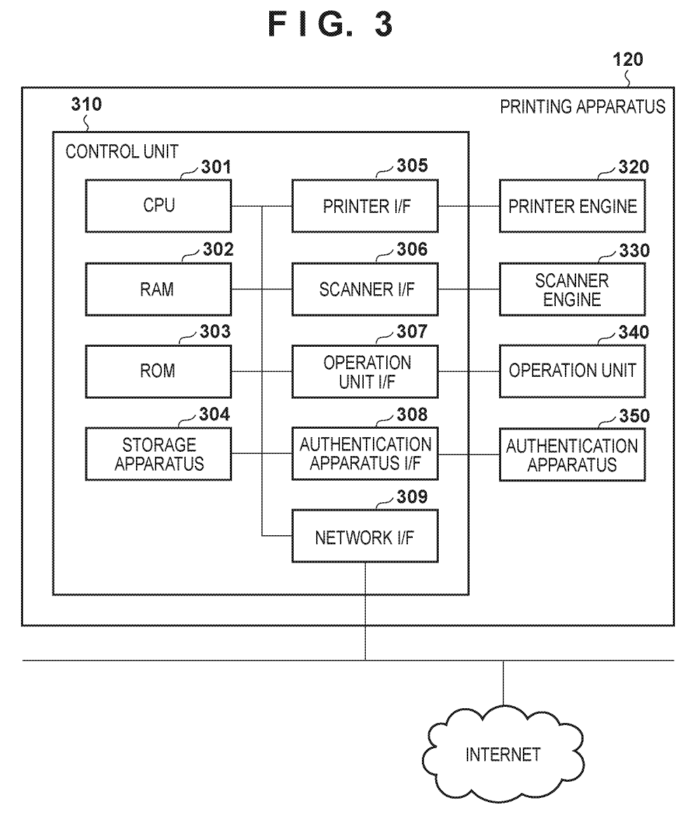

A hardware configuration of the printing apparatus 120 will be described with reference to FIG. 3. Since the printing apparatus 120 is a physical printing apparatus, it is also called a physical printer. The printing apparatus 120 is configured to include a control unit 310, a printer engine 320, a scanner engine 330, an operation unit 340, and an authentication apparatus 350. The control unit 310 is configured to include a CPU 301, a RAM 302, a ROM 303, a storage apparatus 304, a printer I/F 305, a scanner I/F 306, an operation unit I/F 307, an authentication apparatus I/F 308, and a network I/F 309.

The CPU 301 is a general-purpose processing circuit that controls the overall operation of the printing apparatus 120. The RAM 302 is a volatile memory circuit and is used as a temporary storage area such as a work area for processing by the CPU 301. The ROM 303 is a nonvolatile memory circuit, and stores programs and data to be used in the processing of the CPU 301. The storage apparatus 304 is a nonvolatile storage apparatus, and stores programs and data (e.g., print job, image data, and setting information) to be used in the processing of the CPU 301. The storage apparatus 304 may be, for example, an HDD or an SSD. The storage apparatus 304 is also called a secondary storage apparatus. The operation by the printing apparatus 120 may be implemented by the CPU 301 executing a program read from the storage apparatus 304 to the RAM 302.

The printer I/F 305 is an I/F for exchanging signals with the printer engine 320. The printer engine 320 performs printing based on a signal (e.g., an image signal or a print command) supplied from the control unit 310 through the printer I/F 305. The printing may be electrophotographic printing in which toner is transferred to paper and fixed, printing of an inkjet method in which printing is performed by discharging ink onto paper, or three-dimensional printing.

The scanner I/F 306 is an I/F for exchanging signals with the scanner engine 330. The scanner engine 330 supplies a signal (e.g., an image signal) obtained by reading a document to the control unit 310 through the scanner I/F 306. The CPU 301 may process an image signal supplied from the scanner engine 330 and supply a recorded image signal obtained by this to the printer engine 320. The CPU 301 may generate image data based on an image signal supplied from the scanner engine 330 and transmit it to an external apparatus.

The operation unit I/F 307 is an I/F for exchanging signals with the operation unit 340. The operation unit 340 is an apparatus that acquires an input from a user of the printing apparatus 120 and provides the user of the printing apparatus 120 with information. The operation unit 340 may be constituted by, for example, a display panel (e.g., a liquid crystal display), a speaker, a touch panel, a keyboard, a button, a touch screen, or any combination thereof.

The authentication apparatus I/F 308 is an interface that connects the authentication apparatus 350 and the control unit 310. The authentication apparatus 350 is, for example, a card reader that reads an IC card, a biometric authentication apparatus that reads biometric information, or the like, and is used when a user performs authentication to use a printer. The network I/F 309 is an I/F for communicating with an apparatus external to the printing apparatus 120, and is configured to include a communication module.

### Functional Configuration of Information Processing Apparatus

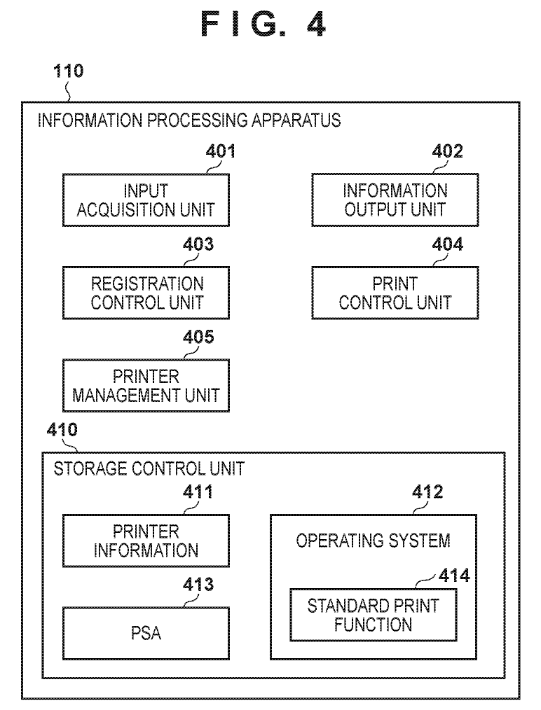

The functional blocks of the information processing apparatus 110 will be described with reference to FIG. 4. The information processing apparatus 110 is configured to include an input acquisition unit 401, an information output unit 402, a registration control unit 403, a print control unit 404, a printer management unit 405, and a storage control unit 410. The storage control unit 410 is configured to include printer information 411, an operating system (OS) 412, and a print support application (PSA) 413. Furthermore, the operating system 412 includes a standard print function 414.

The input acquisition unit 401 uses the input I/F 205 to acquire an input from the user of the information processing apparatus 110. The information output unit 402 uses the output I/F 206 to output information to the user of the information processing apparatus 110. The registration control unit 403 performs processing for registering the logical printer in the first print server 130 and the second print server 140. The print control unit 404 performs processing related to printing by the printer. For example, the print control unit 404 may transmit a print job to the logical printers registered in the first print server 130 and the second print server 140 in accordance with the printing instruction from the user of the information processing apparatus 110. The print control unit 404 may directly (i.e., in the same LAN) transmit a print job to the physical printer in accordance with the printing instruction from the user of the information processing apparatus 110.

The printer management unit 405 manages, as the printer information 411, information regarding a printer to which the information processing apparatus 110 can submit a print job. The printer information 411 includes printer capability information. The printer management unit 405 may search for a printer to which the information processing apparatus 110 can submit a print job.

The storage control unit 410 stores information in the RAM 202 or the storage apparatus 204 or reads information from the RAM 202 or the storage apparatus 204 in accordance with an instruction from another component. The storage control unit 410 may store the printer information 411 and the OS 412. The OS 412 is installed as standard (i.e., at the time of shipment of the information processing apparatus 110) in the information processing apparatus 110. The OS 412 may be updated. The OS 412 has functions for basic management and control of the information processing apparatus 110.

Furthermore, the storage control unit 410 may store the PSA 413. The PSA 413 is an application (plug-in) installed in the OS 412 to extend the standard print function 414. The PSA 413 is provided by the vendor of the printing apparatus 120. The PSA 413 allows the user of the information processing apparatus 110 to use print settings not supported by the standard print function 414.

The standard print function 414 may support a standard protocol. Supporting a protocol may mean interpreting a command conforming to this protocol and operating in accordance with this command. The standard protocol supported by the standard print function 414 may be a protocol standardized by a standardization organization, or may be a de facto standard protocol. Hereinafter, a case where the standard protocol supported by the standard print function 414 is IPP will be described. The following description regarding IPP is also applicable to other standard protocols.

### Functional Configuration of Printing Apparatus

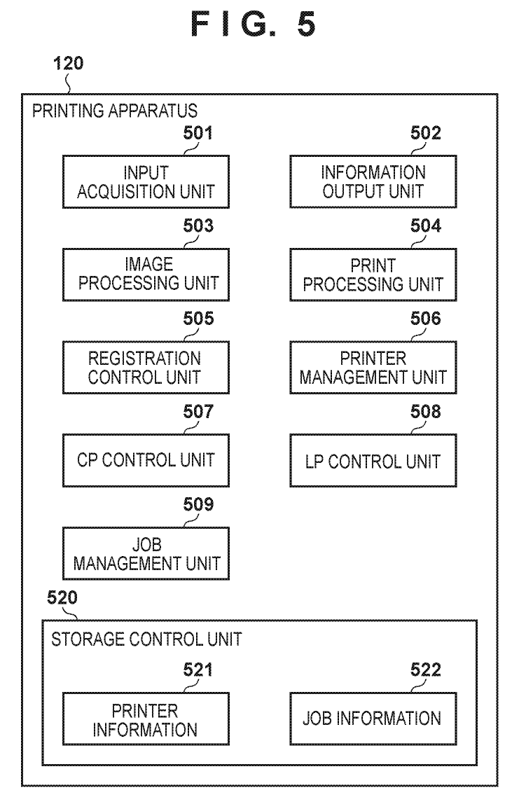

The functional blocks of the printing apparatus 120 will be described with reference to FIG. 5. The printing apparatus 120 is configured to include an input acquisition unit 501, an information output unit 502, an image processing unit 503, a print processing unit 504, and a registration control unit 505. The printing apparatus 120 is configured to include a printer management unit 506, a cloud print (CP) control unit 507, a local print (LP) control unit 508, a job management unit 509, and a storage control unit 520.

The input acquisition unit 501 uses the operation unit I/F 307 to acquire an input from the user of the printing apparatus 120. The information output unit 502 uses the operation unit I/F 307 to output information to the user of the printing apparatus 120. For example, the information output unit 502 displays an operation menu on the operation unit 340. The input acquisition unit 501 acquires an input to the operation menu and notifies another component of the input instruction content. The information output unit 502 displays a result acquired from another component on the operation unit 340.

The image processing unit 503 renders the print job into image data for printing. The print processing unit 504 prints the image data rendered by the image processing unit 503. The registration control unit 505 performs processing for registering, in the second print server 140, a logical printer associated with the printing apparatus 120. The printer management unit 506 manages, as printer information 521, information regarding the printing apparatus 120. The printer information 521 may include, for example, a state of the printing apparatus 120, capability information of the printing apparatus 120, or a cloud printer ID uniquely assigned by the second print server 140 to the logical printer associated with the printing apparatus 120. The printer information 521 may include a local printer ID for the information processing apparatus 110 to identify a printing apparatus in the same LAN. The capability information of the printing apparatus 120 may include, for example, that the printing apparatus 120 has a specific function.

The CP control unit 507 performs processing regarding cloud print. For example, the CP control unit 507 may transfer, to the image processing unit 503, the print data included in the print job received from the second print server 140, and execute printing in accordance with the print job transmitted from the second print server 140. The CP control unit 507 may edit the print job to transmit an event to the second print server 140.

The LP control unit 508 performs processing regarding local print. For example, the LP control unit 508 may respond to a printer search from the information processing apparatus 110. The LP control unit 508 may transfer, to the image processing unit 503, the print data included in the print job directly received from the information processing apparatus 110, and execute printing in accordance with the print job transmitted from the information processing apparatus 110. The job management unit 509 manages information regarding the print job as job information 522. The job information 522 may include a processing state and a processing result of the print job.

The storage control unit 520 stores information in the RAM 302 or the storage apparatus 304 or reads information from the RAM 302 or the storage apparatus 304 in accordance with an instruction from another component. The storage control unit 520 may store the printer information 521 and the job information 522. The storage control unit 520 may manage data as a file system. The storage control unit 520 may distribute the storage destination of each piece of data to the storage apparatus 304, which is a nonvolatile area, and the RAM 302, which is a volatile area. For example, the storage control unit 520 may store the printer information 521 and the job information 522 in the nonvolatile area.

### Functional Configuration of First Print Server

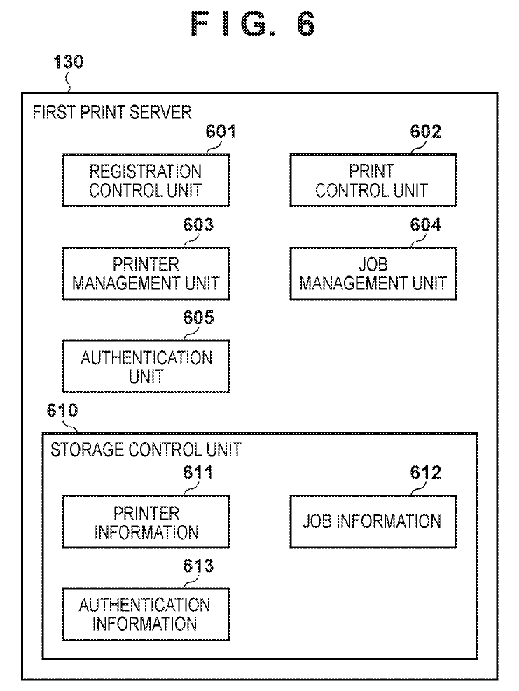

The functional blocks of the first print server 130 will be described with reference to FIG. 6. The first print server 130 is configured to include a registration control unit 601, a print control unit 602, a printer management unit 603, a job management unit 604, an authentication unit 605, and a storage control unit 610. Note that the storage control unit 610 may store printer information 611, job information 612, and authentication information 613 in the RAM 202 or the storage apparatus 204.

The registration control unit 601 performs processing for registering a logical printer. For example, in response to a registration start request from the second print server 140, the registration control unit 601 generates and registers, in the printer information 611, a logical printer associated with the logical printer registered in the second print server 140. The logical printer registered in the printer information 611 is recognized as a printer by the information processing apparatus 110.

The print control unit 602 performs processing related to a print job for the logical printer. For example, the print control unit 602 receives a print job for the logical printer from the information processing apparatus 110, and, based on this, transmits the print job to the logical printer registered in the second print server 140. The print control unit 602 may control an event related to the print job. The event related to the print job may include reception of the print job, for example. In response to reception of an event request from the logical printer registered in the second print server 140, the print control unit 602 may respond with an event related to the printer.

The printer management unit 603 manages, as the printer information 611, the information regarding the logical printer in a state of being registered in the second print server 140. The printer information 611 includes capability information of the logical printer registered in the second print server 140 associated with the logical printer, a cloud printer ID uniquely assigned to the logical printer, and information on a print queue in which the print job is spooled. The job management unit 604 manages, as the job information 612, the information regarding the print job received from the information processing apparatus 110. The job information 612 includes information and state of a print job and print data designated in the print job.

Using the authentication information 613 in which the user information for using the cloud print service provided by the first print server 130 is stored, the authentication unit 605 authenticates the user who has made a login request and controls a user authentication request to an external cloud print service. The storage control unit 610 stores information in the RAM 202 or the storage apparatus 204 or reads information from the RAM 202 or the storage apparatus 204 in accordance with an instruction from another component.

### Functional Configuration of Second Print Server

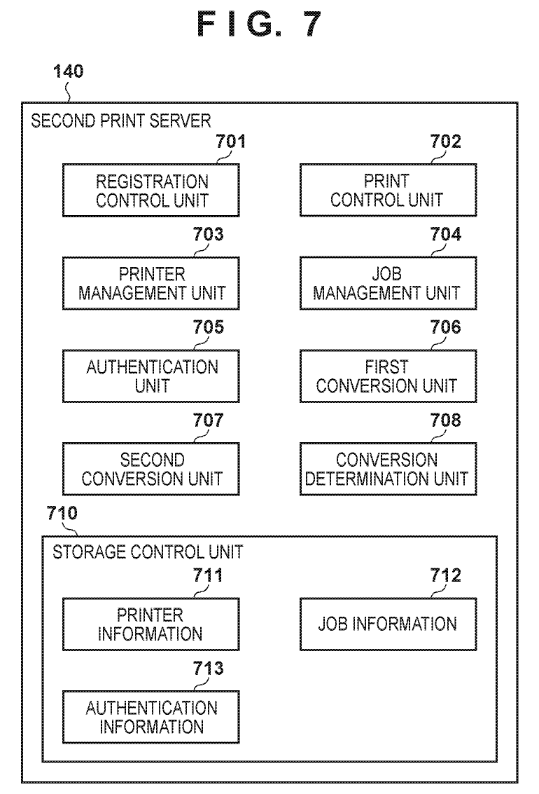

The functional blocks of the second print server 140 will be described with reference to FIG. 7. The second print server 140 is configured to include a registration control unit 701, a print control unit 702, a printer management unit 703, a job management unit 704, and an authentication unit 705. The second print server 140 is configured to include a first conversion unit 706, a second conversion unit 707, a conversion determination unit 708, and a storage control unit 710. Note that the storage control unit 710 may store printer information 711, job information 712, and authentication information 713 in the RAM 202 or the storage apparatus 204.

The registration control unit 701 performs processing for registering a logical printer in the second print server 140. For example, in response to a registration start request from the printing apparatus 120, the registration control unit 701 generates and registers, in the printer information 711, a logical printer associated with the physical printer. The logical printer registered in the printer information 711 is recognized as a printer by the first print server 130.

The print control unit 702 performs processing related to a print job for the logical printer. For example, the print control unit 702 receives a print job for the logical printer from the first print server 130, and, based on this, transmits the print job to the physical printer. The print control unit 702 may control an event related to the print job. The event related to the print job may include reception of the print job, for example. In response to reception of an event request from the physical printer, the print control unit 702 may respond to an event related to the printer.

The printer management unit 703 manages, as the printer information 711, the information regarding the logical printer registered in the second print server 140. The printer information 711 includes capability information of the physical printer associated with the logical printer, a cloud printer ID uniquely assigned to the logical printer, and information on a print queue in which the print job is spooled.

The job management unit 704 manages, as the job information 712, the information regarding the print job received from the first print server 130. The job information 712 includes information and state of a print job and print data designated in the print job. Using the authentication information 713 in which the user information for using the cloud print service provided by the second print server 140 is stored, the authentication unit 705 authenticates the user who has made a login request and controls a user authentication request to an external cloud print service.

The first conversion unit 706 analyzes the print job from the first print server 130 and performs conversion into a print job executable by the printing apparatus 120. For example, the print job from the first print server 130 is expressed by data in Portable Document Format (PDF) and IPP attribute information (IPP attributes). The IPP attribute information is represented by an attribute that defines print settings and apparatus settings of the printing apparatus, output capability of the printing apparatus, and the like, and a value (attribute value) thereof, in addition to the definition regarding printer operation and the definition regarding job operation.

The first conversion unit 706 converts standard attribute information (e.g., copies specifying the number of print copies, and the like) defined by this PDF data and IPP attribute information into a job defined by the CPCA attribute information and Band Description Language (BDL). In this manner, the first conversion unit 706 generates a print job executable by the printing apparatus 120. Note that BDL is a vendor-specific page description language of the printing apparatus 120. The CPCA attribute information is represented by an attribute that defines print settings and apparatus settings of the printing apparatus, output capability of the printing apparatus, and the like, and a value (attribute value) thereof, in addition to the definition regarding printer operation and the definition regarding job operation that can be understood by the printing apparatus 120.

The second conversion unit 707 converts vendor-specific IPP attribute information included in the print job from the first print server 130 into CPCA attribute information. The job management unit 704 merges this CPCA attribute information converted by the second conversion unit 707 with the CPCA attribute information converted by the first conversion unit 706. Note that the first conversion unit 706, the second conversion unit 707, and the job management unit 704 are examples of a "conversion control unit".

The conversion determination unit 708 determines whether or not the print job from the first print server 130 includes vendor-specific IPP attribute information. Then, the conversion determination unit 708 determines whether the print job is converted by the first conversion unit 706 or converted by both the first conversion unit 706 and the second conversion unit 707. The storage control unit 710 stores information in the RAM 202 or the storage apparatus 204 or reads information from the RAM 202 or the storage apparatus 204 in accordance with an instruction from another component.

### Sequence of Cloud Print

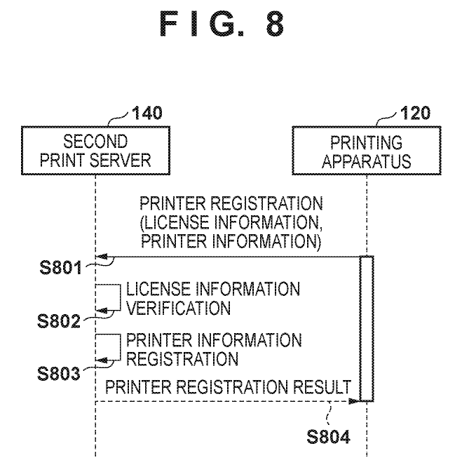

The entire processing of the cloud print according to the embodiment will be described with reference to FIGS. 8 to 11.

### Registration Flow of Printing Apparatus 120 to Second Print Server 140

Processing of registering the printing apparatus 120 in the second print server 140 will be described with reference to FIG. 8. Note that this processing is implemented by the CPU of each of the printing apparatus 120 and the second print server 140 reading a program stored in the ROM or the like into the RAM and executing the program. Communication between the printing apparatus 120 and the second print server 140 is executed via the network I/F of each apparatus. It is assumed that the second print server 140 has completed administrator authentication in advance.

In S801, the registration control unit 505 of the printing apparatus 120 accepts an input of license information from the apparatus administrator. Then, the registration control unit 505 transmits the license information together with the printer information 521 of the printing apparatus 120 to the registration control unit 701 of the second print server 140. Then, the registration control unit 701 receives these pieces of information.

Note that the license is a right for the printing apparatus 120 to use the cloud print service provided by the second print server 140, and is assigned to each tenant such as a company that owns the printing apparatus 120. The printer information 521 is information regarding the printing apparatus 120, and includes, for example, a printer ID for uniquely identifying the printing apparatus 120, print capability of the printing apparatus 120, and information on attached components. The printer information 521 includes print capability, settable print settings, settable IPP attribute information, and CPCA attribute information.

In S802, the registration control unit 701 verifies the license information received from the registration control unit 505. In a case of determining that there is no problem in the license information in S803, the registration control unit 701 transfers the received printer information 521 to the printer management unit 703 and creates a logical printer. Then, the registration control unit 701 registers the created logical printer as the printer information 711. In S804, when the printer information 711 is registered, the registration control unit 701 makes a notification, to the registration control unit 505 of the printing apparatus 120, a printer registration result indicating that printer registration has been performed. Then, the processing ends.

### Registration Flow of Logical Printer to First Print Server 130

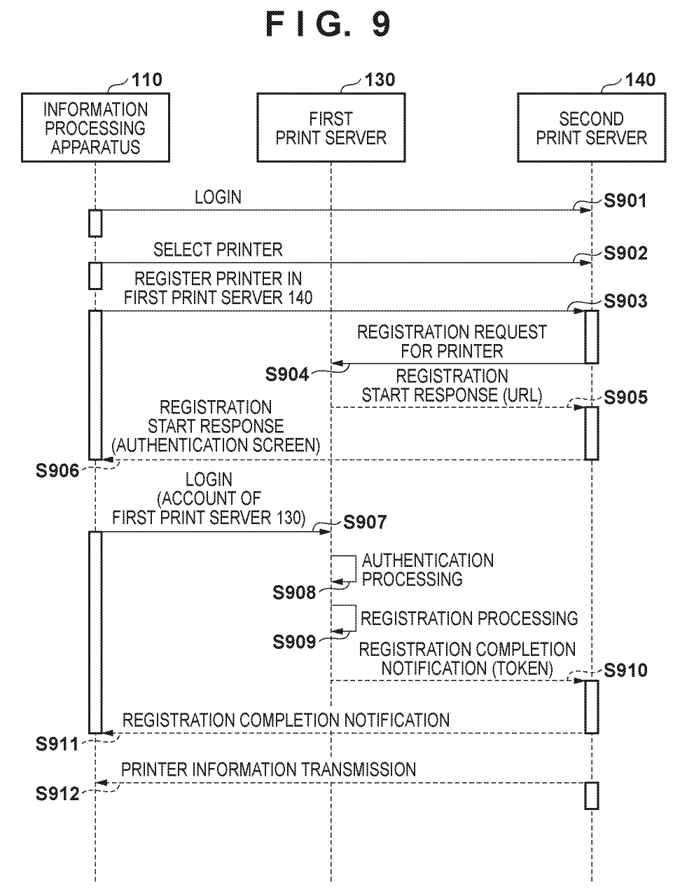

A flow of registering a logical printer from the second print server 140 to the first print server 130 will be described with reference to FIG. 9. Note that this processing is implemented by the CPU of each of the information processing apparatus 110, the first print server 130, and the second print server 140 reading a program stored in the ROM or the like into the RAM and executing the program. Communication between these apparatuses is executed via the network I/F of each apparatus.

In S901, the authentication unit 705 of the second print server 140 accepts, from the information processing apparatus 110, an input of authentication information of a user registered in advance. Then, the authentication unit 705 verifies the input authentication information against the authentication information 713, and determines whether or not the authentication is successful. When the authentication succeeds in S901, the printer management unit 703 accepts in S902 a printer selection instruction from the printer management unit 405 of the information processing apparatus 110.

In S903, the registration control unit 701 of the second print server 140 accepts a registration instruction from the registration control unit 403 of the information processing apparatus 110 in order to register the selected printer in the first print server 130. In S904, upon receiving the registration instruction from the registration control unit 403, the registration control unit 701 transmits a printer registration start request to the registration control unit 601 of the first print server 130. Then, the registration control unit 601 receives this request.

In S905, the registration control unit 601 transmits a registration start response to the registration control unit 701 of the second print server 140. Note that the registration start response is a URL for inputting authentication information that can uniquely recognize the printer and a one-time password for authentication. Then, the registration control unit 701 receives the registration start response from the registration control unit 601. In S906, the registration control unit 701 transmits an authentication information input screen of the first print server 130 to the registration control unit 403 of the information processing apparatus 110. Then, the registration control unit 403 receives this authentication information input screen.

In S907, the registration control unit 403 of the information processing apparatus 110 uses the authentication information input screen to accept an input of authentication information from the user. When the input of the authentication information is completed, the registration control unit 403 transmits the input authentication information to the registration control unit 601 of the first print server 130. Then, the registration control unit 601 receives this authentication information.

In S908, the registration control unit 601 of the first print server 130 causes the authentication unit 605 to verify the received authentication information. The authentication unit 605 verifies the input authentication information against the authentication information 613, and determines whether or not the authentication is successful. Then, in a case where the authentication succeeds, the registration control unit 601 creates in S909 a logical printer from the information on the URL transmitted to the second print server 140 in S905. Then, the printer management unit 603 registers this logical printer information as the printer information 611.

When the registration of the printer information 611 is completed, the registration control unit 601 transmits in S910 a registration completion response and access token information to be used in subsequent communication to the registration control unit 701 of the second print server 140. Then, the registration control unit 701 receives these pieces of information. In S911, upon receiving the registration completion response from the registration control unit 601, the registration control unit 701 transmits a registration completion notification to the registration control unit 403 of the information processing apparatus 110. Then, the registration control unit 403 receives this registration completion notification. When the transmission of the registration completion notification is completed, the printer management unit 703 of the second print server 140 transmits in S912 logical printer information to the printer management unit 405 of the information processing apparatus 110. Then, the printer management unit 405 receives this logical printer information. Then, the processing ends.

### Registration Flow of Print Job to Second Print Server 140

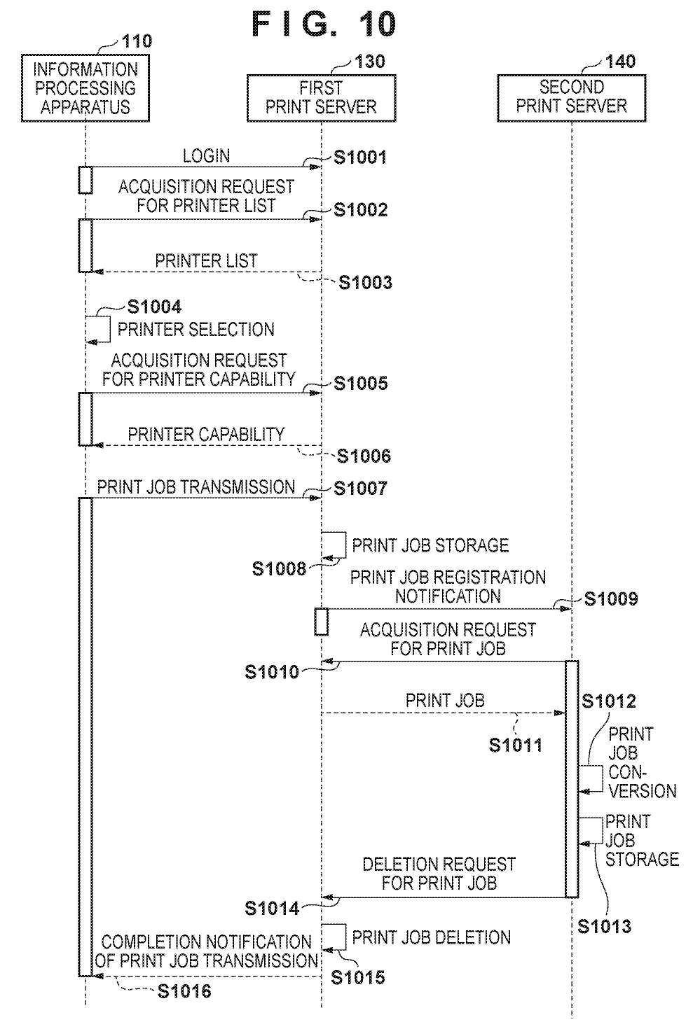

A registration flow of a print job to the second print server 140 will be described with reference to FIG. 10. Note that this processing is implemented by the CPU of each of the information processing apparatus 110, the first print server 130, and the second print server 140 reading a program stored in the ROM or the like into the RAM and executing the program. Communication between these apparatuses is executed via the network I/F of each apparatus.

In S1001, the authentication unit 605 of the first print server 130 receives, from the information processing apparatus 110, an input of authentication information of the user in a state of being registered in advance. Then, the authentication unit 605 verifies the input authentication information against the authentication information 613, and determines whether or not the authentication is successful. In S1002, the printer management unit 405 of the information processing apparatus 110 transmits an acquisition request for a printer list available to the user to the printer management unit 603. Then, the printer management unit 603 receives the acquisition request for the printer list. In S1003, the printer management unit 603 returns the printer list available to the user to the printer management unit 405 with reference to the printer information 611. Then, the printer management unit 405 receives this printer list.

In S1004, the printer management unit 405 of the information processing apparatus 110 selects a printer to be used from the received printer list. In S1005, the printer management unit 405 requests the printer management unit 603 of the first print server 130 to transmit the capability available to the selected printer. Then, the printer management unit 603 receives an acquisition request for this printer capability. In S1006, the printer management unit 603 refers to the printer information 611 stored in the storage medium by the storage control unit 610. Then, the printer management unit 603 returns the capability available to the printer to the printer management unit 603.

In S1007, the print control unit 404 of the information processing apparatus 110 generates a print job using the received capability available to the printer. Then, the print control unit 404 transmits this print job to the print control unit 602 of the first print server 130. Note that this print job may be a print job defined by PDF and IPP attribute information. Then, the print control unit 602 receives this print job.

In S1008, the print control unit 602 causes the job management unit 604 to store the received job as the job information 612. In S1009, the print control unit 602 transmits a print job registration notification to the print control unit 702 of the second print server 140. Then, the print control unit 702 receives this print job registration notification. In S1010, the print control unit 702 requests the print control unit 602 of the first print server 130 to transmit the print job. Then, the print control unit 602 receives this request.

In S1011, the print control unit 602 (an example of a "communication unit") transmits, as a print job, the job information 612 stored in S1008 to the print control unit 702 of the second print server 140. Then, the print control unit 702 (an example of an "acquisition unit") receives this print job (an example of a "first print job"). In S1012, the conversion determination unit 708 determines processing of converting IPP attribute information of the print job received by the print control unit 702. Then, the first conversion unit 706 and the second conversion unit 707 convert this print job into a print job (an example of a "second print job") executable by the printing apparatus 120. Note that the print job executable by the printing apparatus 120 may be a print job defined by the CPCA attribute information and BDL.

In S1013, the job management unit 704 of the second print server 140 stores, as the job information 712, the print job for which conversion has been completed. In S1014, the print control unit 702 makes a notification of a print job deletion request to the print control unit 602 of the first print server 130. Then, the print control unit 602 receives this deletion request. In S1015, the job management unit 604 deletes the job information 612. Then, the job management unit 604 returns the completion of the transmission of the print job to the print control unit 404 of the information processing apparatus 110. Then, the processing ends.

### Execution Flow of Print Job in Printing Apparatus 120

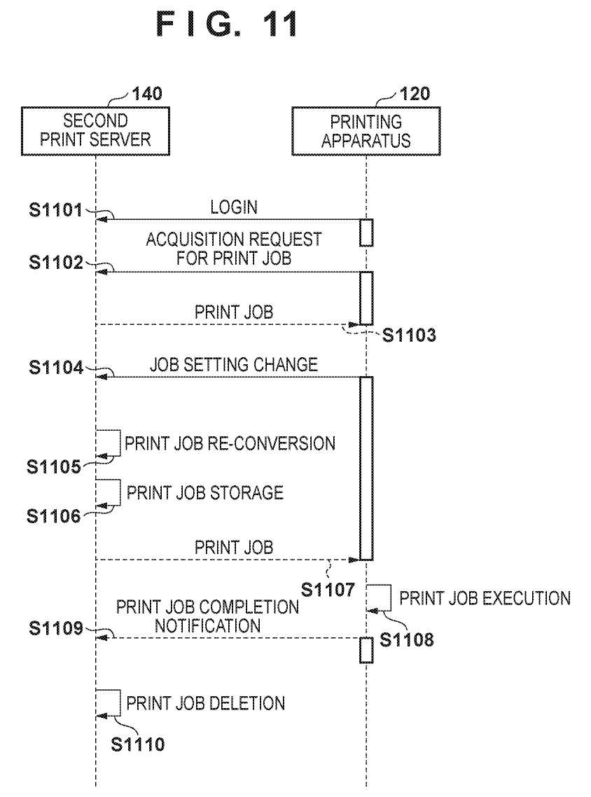

An execution flow of a print job in the printing apparatus 120 will be described with reference to FIG. 11. Note that this processing is implemented by the CPU of each of the printing apparatus 120 and the second print server 140 reading a program stored in the ROM or the like into the RAM and executing the program. Communication between the printing apparatus 120 and the second print server 140 is executed via the network I/F of each apparatus. It is assumed that the second print server 140 has completed administrator authentication in advance.

In S1101, the authentication unit 705 of the second print server 140 accepts, from the printing apparatus 120, an input of authentication information of the user in a state of being registered in advance. Then, the authentication unit 705 verifies the input authentication information against the authentication information 713, and determines whether or not the authentication is successful. In S1102, the CP control unit 507 of the printing apparatus 120 requests the print control unit 702 of the second print server 140 for acquisition of a print job associated with the user. Then, the print control unit 702 receives an acquisition request for this print job.

In S1103, the print control unit 702 (an example of an "output unit") replies with a print job to the CP control unit 507 of the printing apparatus 120 (an example of an "image forming apparatus"). Then, the CP control unit 507 receives this print job. Then, the job management unit 509 stores the received print job as the job information 522. Note that the print job may be a print job defined by BDL and the CPCA attribute information. The CP control unit 507 may acquire only the CPCA attribute information.

In S1104, in a case where there is a change in the CPCA attribute information accompanying the change in the job setting, the input acquisition unit 501 of the printing apparatus 120 accepts the change from the user. Then, the job management unit 509 transmits the print job setting changed by the CP control unit 507 to the print control unit 702 of the second print server 140. Then, the print control unit 702 receives this changed print job setting.

In S1105, the conversion determination unit 708 of the second print server 140 determines the conversion processing using the CPCA attribute information of the print job setting. Then, the first conversion unit 706 and the second conversion unit 707 re-convert a corresponding print job to a print job executable by the printing apparatus 120 based on the print job setting with which the print control unit 702 received. Note that when the CPCA attribute information corresponding to the standard IPP attribute information is changed, the first conversion unit 706 may re-convert the CPCA attribute information. In a case where the CPCA attribute information corresponding to the vendor-specific IPP attribute information is changed, the second conversion unit 707 may re-convert the CPCA attribute information.

In S1106, the job management unit 704 overwrites and stores, as the job information 712, the print job for which re-conversion has been completed. In S1107, the print control unit 702 transmits the re-converted print job (an example of a "third print job") to the CP control unit 507 of the printing apparatus 120. Then, the CP control unit 507 receives this print job. Then, the job management unit 509 stores the received print job as the job information 522.

In S1108, upon accepting an instruction from the user, the print processing unit 504 executes a print job. When the execution of the print job is completed, the CP control unit 507 transmits in S1109 a print job completion notification to the print control unit 702 of the second print server 140. Then, the print control unit 702 receives this notification. In S1110, the job management unit 704 of the second print server 140 deletes the job information 712. Then, the processing ends.

### Specific Example of Registration Flow of Print Job to Second Print Server 140

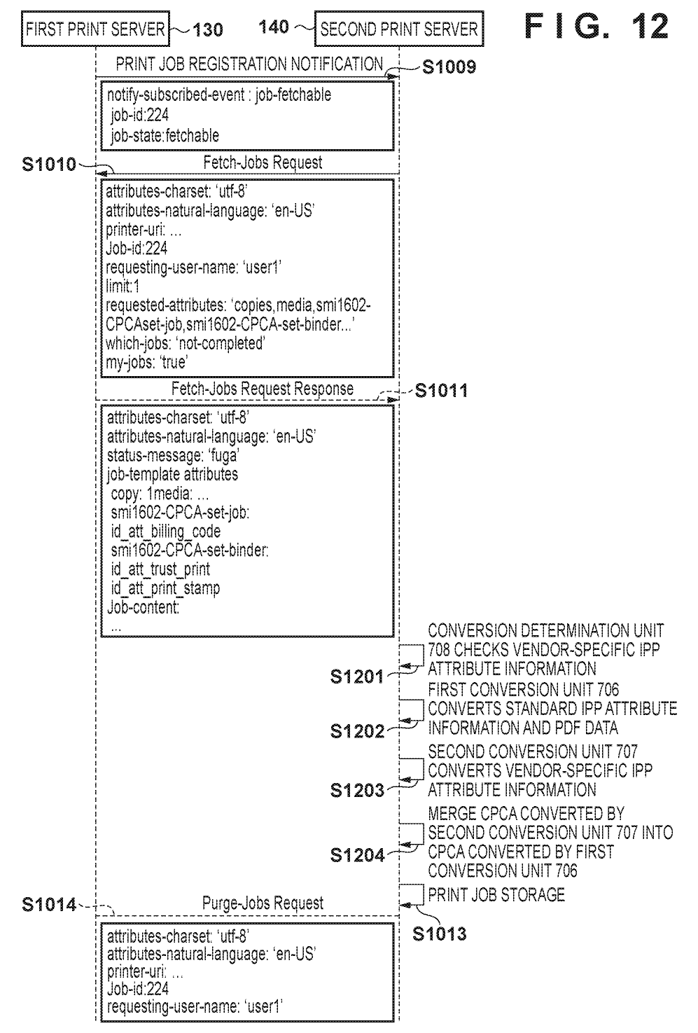

An example of a detailed flow of registration of a print job of the second print server 140 will be described with reference to FIG. 12. That is, the flow of FIG. 12 exemplifies specific processing of S1009 to S1014 of FIG. 10. Note that this processing is implemented by the CPU of each of the first print server 130 and the second print server 140 reading a program stored in the ROM or the like into the RAM and executing the program. Communication between these apparatuses is executed via the network I/F of each apparatus.

In S1009, the print control unit 602 of the first print server 130 makes a notification, to the print control unit 702 of the second print server 140, of the fact that the job can be fetched and the job ID that can be fetched. Then, the print control unit 702 receives this notification. In S1010, the print control unit 702 transmits a Fetch-Jobs request of the notified job ID to the print control unit 602 of the first print server 130. Then, the print control unit 602 receives this request.

In S1011, the print control unit 602 transmits, as a response, the detailed information of the print job designated by the Fetch-Jobs request to the print control unit 702 of the second print server 140. Here, the response includes, for example, job-template attributes, smi1602-CPCA-set-job, smi1602-CPCA-set-binder, and Job-content. Furthermore, job-template attributes include values such as copy and media.

These values such as copy and media are standard IPP attribute information. On the other hand, smi1602-CPCA-set-job and smi1602-CPCA-set-binder are vendor-specific IPP attribute information. Job-content is binary data of PDF. At this time, these pieces of information may be discarded in a case where the third IPP attribute information (IPP attribute information used in, for example, AirPrint (registered trademark) and Mopria (registered trademark)) other than the standard IPP attribute information and the vendor-specific IPP attribute information is included. Then, the print control unit 702 receives the detailed information of this print job.

In S1201, the conversion determination unit 708 of the second print server 140 determines whether or not vendor-specific IPP attribute information (an example of "third print setting information") is included in job-template attributes. Here, the conversion determination unit 708 is assumed to determine that vendor-specific IPP attribute information is included in job-template attributes. In S1202, the first conversion unit 706 converts the standard IPP attribute information (an example of "first print setting information") into CPCA attribute information (an example of "second print setting information"). The first conversion unit 706 converts the binary data of PDF (an example of "print data") that is Job-content into BDL. In S1203, the second conversion unit 707 converts the vendor-specific IPP attribute information into CPCA attribute information (an example of "fourth print setting information").

In S1204, the job management unit 704 merges the CPCA attribute information converted by the second conversion unit 707 with the CPCA attribute information converted by the first conversion unit 706. In this manner, the job management unit 704 generates the CPCA attribute information including the standard IPP attribute information and the vendor-specific IPP attribute information. Note that there may be IPP attribute information that is handled as the same CPCA attribute information when the standard IPP attribute information and the vendor-specific IPP attribute information are converted into the CPCA attribute information. In such a case, the job management unit 704 may merge the CPCA attribute information converted by the second conversion unit 707 (an example of "one conversion unit") in preference to the CPCA attribute information converted by the first conversion unit 706 (an example of an "other conversion unit"). Alternatively, the job management unit 704 may merge the CPCA attribute information converted by the first conversion unit 706 (an example of "one conversion unit") in preference to the CPCA attribute information converted by the second conversion unit 707 (an example of an "other conversion unit").

In S1013, the job management unit 704 stores BDL and the CPCA attribute information as the job information 712. In S1014, the print control unit 702 transmits a Purge-Jobs request to the print control unit 602 of the first print server 130. Then, the print control unit 602 receives this request and deletes the corresponding job information 612. Then, the processing proceeds to S1015 of FIG. 10.

### Another Example of Registration Flow of Print Job to Second Print Server 140

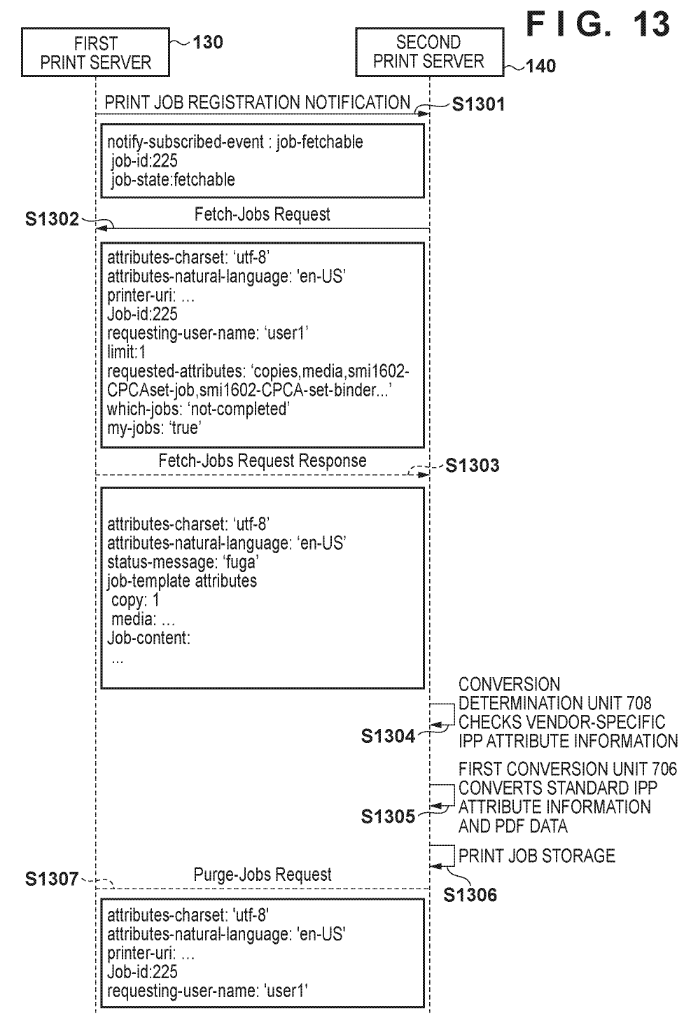

Another example of a detailed flow of registration of a print job to the second print server 140 will be shown with reference to FIG. 13. That is, the flow of FIG. 13 shows another example of the specific processing of S1009 to S1014 of FIG. 10. Note that this processing is implemented by the CPU of each of the first print server 130 and the second print server 140 reading a program stored in the ROM or the like into the RAM and executing the program. Communication between these apparatuses is executed via the network I/F of each apparatus.

S1301 to S1305 are similar to S1009 to S1202 in FIG. 12, and therefore the description thereof will be omitted. However, in the flow of FIG. 13, the response to be transmitted from the first print server 130 to the second print server 140 in S1303 does not include smi1602-CPCA-set-job and smi1602-CPCA-set-binder. Therefore, the conversion determination unit 708 of the second print server 140 is assumed to determine in S1304 that vendor-specific IPP attribute information is not included in job-template attributes. Hence, after the execution of S1305, S1203 and S1204 are not executed. Then, the processing proceeds to S1306. Since S1306 and S1307 are similar to S1013 and S1014 in FIG. 12, the description thereof will be omitted. Then, the processing proceeds to S1015 of FIG. 10.

### One Aspect of Actions and Effects

According to the information processing system 10 as described above, in a case where vendor-specific IPP attribute information is included in a print job, the second conversion unit 707 converts the vendor-specific IPP attribute information into CPCA attribute information that can be recognized by the printing apparatus 120. Hence, the printing apparatus 120 can perform printing by reflecting print settings not supported by the standard print function of the OS installed in the information processing apparatus 110. As shown in FIGS. 12 and 13, the conversion determination unit 708 determines whether or not vendor-specific IPP attribute information is included in the print job. Then, the generation method for the print job is switched depending on this determination result. Hence, the processing load can be reduced.

### Modification

The first print server 130 and the second print server 140 may be replaced by one print server including the functions of these two print servers.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-038548, filed Mar. 11, 2025, which is hereby incorporated by reference herein in its entirety.

What is claimed is:

1. A cloud print server system which is connected to a first cloud print server system and provides a cloud print service, the cloud print server system comprising:
one or more memory devices that store a set of instructions; and
one or more processors that execute the set of instructions to:
acquire a first print job including first print setting information supported by a standard print function of an operating system; and
convert the first print setting information included in the first print job that is acquired into second print setting information defined by a predetermined protocol for using the cloud print service, wherein
the one or more processors further execute instructions in the one or more memory devices to:
convert third print setting information into fourth print setting information defined by the predetermined protocol in a case where the first print job further includes the third print setting information that extends the standard print function.

2. The cloud print server system according to claim 1, wherein
the first print setting information and the third print setting information include IPP attribute information, and
the second print setting information and the fourth print setting information include CPCA attribute information.

3. The cloud print server system according to claim 1, wherein
the one or more processors execute instructions in the one or more memory devices to:
convert the first print setting information into the second print setting information;
determine whether or not the first print job includes the third print setting information; and
convert the third print setting information into the fourth print setting information depending on a determination result.

4. The cloud print server system according to claim 3, wherein
the one or more processors execute instructions in the one or more memory devices to:
in a case of determining that the first print job includes the third print setting information,
convert the third print setting information into the fourth print setting information; and
generate a second print job including the second print setting information and the fourth print setting information that are converted.

5. The cloud print server system according to claim 3, wherein
the one or more processors execute instructions in the one or more memory devices to:
in a case of determining that the first print job does not include the third print setting information,
not execute conversion from the third print setting information to the fourth print setting information; and
generate a second print job including the second print setting information that is converted.

6. The cloud print server system according to claim 4, wherein
the one or more processors execute instructions in the one or more memory devices to:
include one of converted print setting information in the second print job in preference to another converted print setting information in a case where the second print setting information that is converted and the fourth print setting information that is converted are same.

7. The cloud print server system according to claim 4, wherein
the first print job further includes print data and wherein the one or more processors further execute instructions in the one or more memory devices to:
convert the print data into data defined by BDL.

8. The cloud print server system according to claim 4, wherein
the one or more processors further execute instructions in the one or more memory devices to:
output the second print job that is generated to an image forming apparatus.

9. The cloud print server system according to claim 8, wherein
the one or more processors further execute instructions in the one or more memory devices to:
acquire a change in print setting information included in the second print job from the image forming apparatus; and
generate a third print job reflecting the change in the print setting information that is acquired.

10. An information processing system comprising:
the cloud print server system according to claim 8; and
another cloud print server system, wherein
the other cloud print server system including:
one or more memory devices that store a set of instructions; and
one or more processors that execute the set of instructions to:
communicate with the cloud print server system; and
control storage of the first print job, wherein in the other cloud print server system, the one or more processors execute instructions in the one or more memory devices to:
transmit the first print job in a stored state to the cloud print server system, wherein in the cloud print server system, the one or more processors execute instructions in the one or more memory devices to:
output the second print job to the image forming apparatus; and
output a request for deletion of the storage of the first print job to the other cloud print server system, wherein in the other cloud print server system, the one or more processors execute instructions in the one or more memory devices to:
receive the request from the cloud print server system; and
delete the storage of the first print job in response to the request.

11. A control method for a cloud print server system which is connected to a first cloud print server system and provides a cloud print service, the control method comprising:
acquiring a first print job including first print setting information supported by a standard print function of an operating system; and
converting the first print setting information included in the first print job that is acquired into second print setting information defined by a predetermined protocol for using the cloud print service, wherein
further converting third print setting information into fourth print setting information defined by the predetermined protocol in a case where the first print job further includes the third print setting information that extends the standard print function.

12. A non-transitory computer-readable storage medium storing a computer program for causing a computer to execute each step in a control method for a cloud print server system that is connected to a first cloud print server system and provides a cloud print service, the control method comprising:
acquiring a first print job including first print setting information supported by a standard print function of an operating system; and
converting the first print setting information included in the first print job that is acquired into second print setting information defined by a predetermined protocol for using the cloud print service, wherein
further converting third print setting information into fourth print setting information defined by the predetermined protocol in a case where the first print job further includes the third print setting information that extends the standard print function.
